(19) United States
(12) Patent Application Publication
(10) Pub. No.: US 2021/0129129 A1
(43) Pub. Date: May 6, 2021

(54) SYSTEMS AND METHODS USING PIPETTES FOR PERFORMING CHEMICAL AND/OR BIOLOGICAL PROCESSES

(71) Applicant: iRepertoire, Inc., Huntsville, AL (US)

(72) Inventors: Jian Han, Huntsville, AL (US); Song Li, Madison, AL (US); Jeff Bertrand, Hazel Green, AL (US)

(21) Appl. No.: 17/020,349

(22) Filed: Sep. 14, 2020

Related U.S. Application Data
(60) Provisional application No. 62/899,489, filed on Sep. 12, 2019.

(51) Int. Cl. B01L 3/02

(52) U.S. Cl. CPC B01L 3/021; B01L 2300/0867

(57) ABSTRACT

A system for performing a chemical and/or biological process has a pipette for processing material used in the process. The pipette can have a tip that can pierce a sealing material of a chamber and then be placed in contact with the bottom surface of the chamber that is housing a material used in the process. The tip has a plurality of passageways with openings located along the outer perimeter of the tip. The placement of the openings at the outer perimeter permits the tip to be placed on the bottom surface of a chamber such that most of the material in the chamber can be extracted by the pipette. In addition, the placement of the tip on the bottom surface of the chamber with openings along the outer perimeter of the tip permits the pipette to agitate existing material in the chamber when the pipette is providing additional material into the chamber.

### RELATED APPLICATION

This application claims priority to U.S. Provisional Patent Application No. 62/899,489 filed on Sep. 120, 2019, titled “Systems and Methods Using Pipettes for Performing Chemical and/or Biological Processes,” the entire contents of which are incorporated herein.

### FIELD OF THE DISCLOSURE

The present application is generally directed to systems and methods for performing chemical and/or biological processes. More specifically, the present application is directed to systems and methods that perform chemical and/or biological processes using a pipette for moving reagents and other materials into and out of at least one reaction chamber.

### RELATED ART

Systems for performing chemical and/or biological processes (e.g., dimer avoided multiplex polymerase chain reaction (dam-PCR) or amplicon rescue multiplex polymerase chain reaction (arm-PCR)) can use a pipette (having either an integral or detachable tip) to move reagents and other materials during the process. Often the reagents (or other materials) used in a process are stored in chambers that are sealed with aluminum foil. In order to puncture the foil seal for a chamber and access the reagent, the pipette can be provided with a chiseled tip resulting in a pointed end that pierces the foil seal. After piercing the foil seal, the pipette can be used to draw reagent or other material from the chamber and move the material to a reaction chamber during performance the process.

During the course of the process many different reagents and other materials may be moved to and from the reaction chamber. Between steps it is often desirable to clean the reaction chamber by repeatedly rinsing and removing a cleaning fluid. These cleaning steps can be time consuming, thereby undesirably extending the duration of the process, and the results of the process can be adversely affected if residual reagents or materials are left in the reaction chamber. In addition, in some processes, magnetic beads can be used to collect material (e.g., nucleic acid) at several points during a process. After cleaning, the magnetic beads should be uniformly re-suspended in the liquid for the next step of the process. Better techniques for transferring reagents and other material into and out of the reaction chamber, for re-suspending magnetic beads uniformly in the reaction chamber, and for reducing the time required to perform the process are generally desired.

### BRIEF DESCRIPTION OF THE DRAWINGS

The disclosure can be better understood with reference to the following drawings. The elements of the drawings are not necessarily to scale relative to each other, emphasis instead being placed upon clearly illustrating the principles of the disclosure. Furthermore, like reference numerals designate corresponding parts throughout the several views.

FIG. 1 is a block diagram showing an embodiment of a system for performing PCR amplification.

FIG. 2 is a side plan view of an embodiment of a processor module.

FIG. 3 is a rear perspective view of the processor module of FIG. 2.

FIG. 4 shows a perspective view of an embodiment of a cassette.

FIG. 5 shows an exploded view of the cassette shown in FIG. 4.

FIG. 6 is a perspective view of an embodiment of a pipette.

FIG. 7 is a top view of the pipette shown in FIG. 6.

FIG. 8 is a cross-sectional view of the pipette of FIG. 6 taken along line A-A of FIG. 7.

FIG. 9 is an enlarged perspective view showing only the tip of the pipette of FIG. 6.

FIG. 10 is an enlarged side view showing only the tip of the pipette of FIG. 6.

FIG. 11 is an enlarged end view showing only the tip of the pipette of FIG. 6.

FIGS. 12-14 are partial cross-sectional views of an embodiment of the pipette being inserted into a chamber.

### DETAILED DESCRIPTION

Embodiments of the present disclosure generally pertain to systems and methods that use a pipette for performing chemical and/or biological processes (e.g., dimer avoided multiplex polymerase chain reaction (dam-PCR) or amplicon rescue multiplex polymerase chain reaction (arm-PCR)). As noted above, a pipette having a chiseled tip or a flat tip is often used to move reagents and other materials into and out of the reaction chamber. When such a chiseled tip is inserted into a chamber or well, the tip contacts the bottom surface of the chamber or well such that a hole for receiving material from the chamber into the pipette is slightly raised from the bottom surface of the chamber. When such a flat tip is inserted into a chamber or well, the tip contacts the bottom surface of the chamber or well such that a hole for receiving material from the chamber into the pipette can be blocked unless the flat tip of the pipette is slightly raised from the bottom surface of the chamber. In order to prevent the hole for receiving material in the flat tip from becoming blocked, the user of the pipette has to carefully position the flat tip of the pipette as close to the bottom surface of the chamber as possible while still permitting material from the chamber to be received in the hole. Requiring a user to exhibit such positional accuracy with the pipette and flat tip can increase the time needed to perform the extraction of material from the chamber or result in an excessive amount of material remaining in the chamber if the user is not accurate when positioning the flat tip. As a result in either case, the pipette may be unable to pull all of the reagent (or other material) from the chamber thereby undesirably leaving a residual amount of the material in the chamber. The remaining reagent (or other material) in the chamber can impact process performance by possibly requiring additional rinsing procedures, which may increase the cost and time of the process, before subsequent steps in the process can be completed. In addition, the leaving of residual amounts of reagent in the chamber can also inhibit reactions in subsequent steps of the process thereby reducing the efficiency of the process.

In embodiments of the present disclosure, a pipette can be mounted in a cassette or used as part of a pipetter or pipetting device and have a tip that can pierce a sealing material of a chamber and then be placed in contact with the bottom surface of the chamber. In some embodiments, the tip can be integral with the rest of the body of the pipette, but in other embodiments, the tip can be a separate part that can be removably attached to the body of the pipette. The chamber can store or house a material (e.g., a reagent or beads) used for the chemical and/or biological process. The tip of the pipette can have a plurality of passageways with openings at the end of the pipette. The openings can be located along the outer perimeter of the tip. The placement of the openings at the end of the tip and along the outer perimeter of the tip permits the pipette to extract most (if not all) of the material in the chamber via the openings when the tip is placed on the bottom surface of a chamber. The ability to place and hold the tip of the pipette of the present disclosure on the bottom surface of the chamber and extract all of the material from the chamber removes the need for a user to precisely locate the tip of the pipette in the chamber in order to extract most material from the chamber. A user can place and hold the tip of the pipette on the bottom surface of the chamber and extract material without concern for blocking the opening (or hole) to the pipette for receiving material. In addition, by placing the tip on the bottom surface of the chamber, the pipette can agitate existing material in the chamber when providing additional material to the chamber. For example, the flow of reagent into a chamber through the passageways can operate to agitate beads that are already located within the chamber such that the beads become suspended and better dispersed in the reagent. The size and placement of the passageways permits the flow from the passageways to generate turbulence in the chamber in order to agitate the beads from their previous position in the chamber and suspend the beads in the provided reagent.

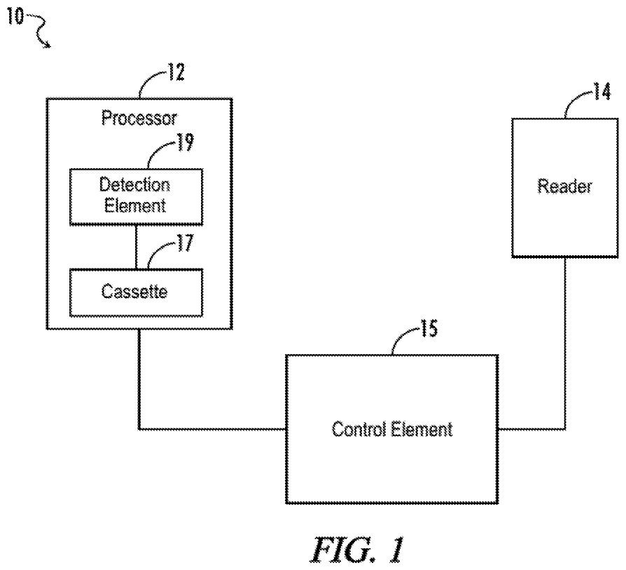

FIG. 1 depicts an embodiment of a system 10 for performing chemical and/or biological processes such as PCR amplification of DNA and/or RNA obtained from an organic specimen. The system 10 enables the performance of chemical and/or biological processes such as dam-PCR, a technique that has been previously described in International Publication No. WO 2018/165593 entitled “Dimer Avoided Multiplex Polymerase Chain Reaction for Amplification of Multiple Targets,” which is incorporated herein by reference or arm-PCR, a technique that has been described previously in U.S. Pat. No. 7,999,092, entitled “Amplicon Rescue Multiplex Polymerase Chain Reaction for Amplification of Multiple Targets,” which is also incorporated herein by reference. The system 10 includes a processor 12 and an optional reader 14 coupled to a control element 15. In one embodiment, the control element 15 includes a computing device, such as a desktop computer or laptop computer, although other types of control elements 15 are possible in other embodiments. The control element 15 can communicate with the processor 12 and the reader 14 (if used) in order to control the operation of the processor 12 and the reader 14. The control element 15 can further receive data indicative of the specimen's amplified DNA from the reader 14 (if used) and produce an output indicating a comparison of the amplified DNA to predefined data, which comparison can be used in diagnosing the specimen.

The processor 12 can receive a self-contained cassette 17 containing the organic specimen, engage with the cassette 17, and manipulate the cassette 17 such that the process is performed on the specimen within the cassette 17. An exemplary cassette is disclosed in U.S. Pat. No. 8,383,068, entitled “Apparatus for Performing Amplicon Rescue Multiplex PCR,” which is incorporated herein by reference. In one embodiment, the processor 12 includes at least one detection element 19 for detecting the cassette 17 within the processor 12 and determining a variety of information about the cassette 17. The detection element 19 transmits the information to the control element 15, and the control element 15 manipulates the processor 12 based on the received information.

The reader 14 (if used) can receive the cassette 17 after the cassette 17 has been processed by the processor 12 and capture an image of a microarray (not shown) on the cassette 17. The microarray indicates detection of the DNA, which is produced by PCR amplification. In one embodiment, the image of the microarray includes a digital image, although other types of images are possible in other embodiments. The reader 14 can transmit the image to the control element 15 as test data in order to allow the control element 15 to analyze the test data and compare the test data to the predefined data. Additional information regarding the operation of the system 10 is disclosed in U.S. Pat. No. 10,345,320, entitled “Systems and Methods for Performing Amplicon Rescue Multiplex Polymerase Chain Reaction (PCR),” which is incorporated herein by reference.

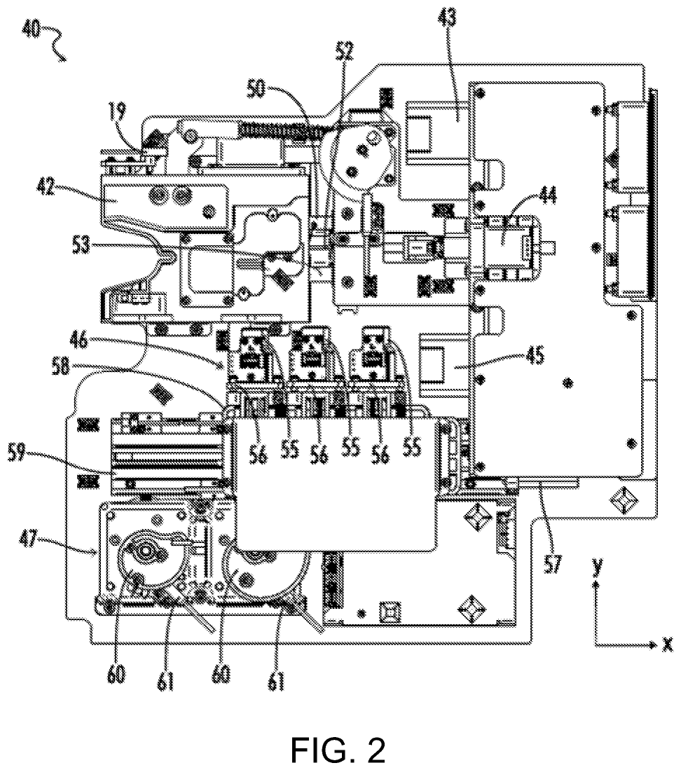

FIG. 2 shows an embodiment of a processor module 40 of the processor 12 of FIG. 1. In this regard, the processor 12 can include one or more processor modules 40. In one embodiment, the processor 12 can have four processor modules 40 positioned side by side within a housing (not shown), although any number of processor modules 40 may be utilized in other embodiments. Each processor module 40 can receive and process a single cassette 17 such that techniques associated with the process are performed upon a specimen within the cassette 17. The processor module 40 includes a receptacle 42 for receiving and housing the cassette 17 while the cassette 17 is located within the module 40. The module 40 also has at least one detection element 19 located adjacent to the receptacle 42 for detecting an identifier (not shown) located on an outer surface of the cassette 17 when the cassette 17 is positioned within the receptacle 42. The detection element 19 detects the identifier and transmits the identifier to the control element 15 in order to allow the control element 15 to map the identifier from the cassette 17 to corresponding predefined settings and/or instructions for the processor module 40.

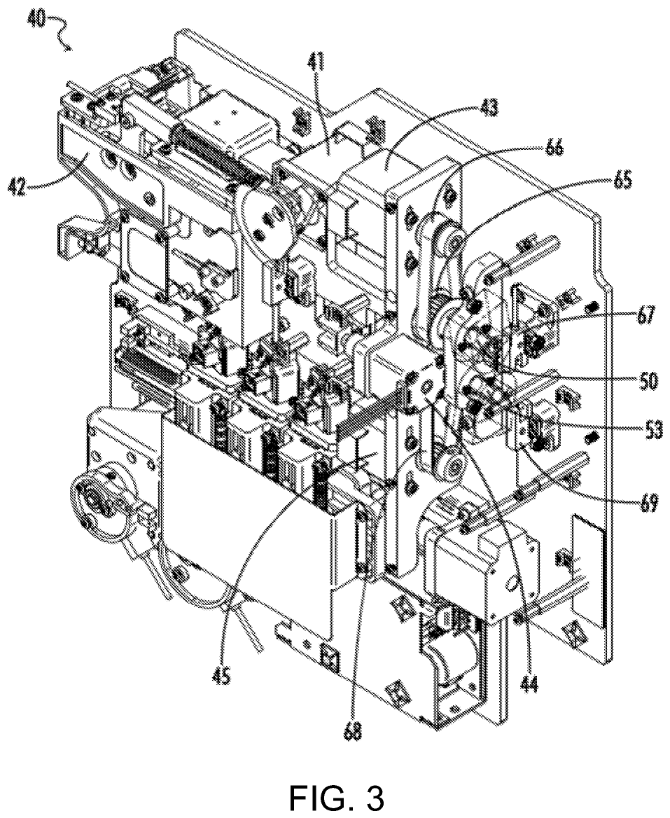

The processor module 40 can include an onboard control element which controls the operation of the processor module 40 based upon the settings and/or other control instructions from the control element 15. In this regard, the onboard control element controls the operation of a latch motor 41 (see FIG. 3), a cam bar motor 43, a pump pin motor 44, a lead screw motor 45, a heater assembly 46, and a lifter assembly 47. The latch motor 41 controls the operation of a latch (not shown) and the cam bar motor 43 can be coupled to a cam bar shaft 50 and control rotation of the cam bar shaft 50. In one embodiment, the cam bar motor 43 can be positioned behind the receptacle 42 within the module 40. The cam bar shaft 50 extends horizontally into a rear opening (not shown) of the receptacle 42 and engages with a cam bar (not shown) of the cassette 17 in order to control clockwise and counterclockwise rotation of the cam bar and manipulate movement of a pipette (not shown) upward and/or downward in a vertical direction within the cassette 17. The pump pin motor 44 can be coupled to a plunger 52 and controls lateral movement of the plunger 52. The pump pin motor 44 can be positioned behind the receptacle 42 within the module 40, and the plunger 52 can extend laterally into the receptacle 42 via an opening (not shown) in the receptacle 42. The plunger 52 can engage with a pump pin (or “push rod”) (not shown) of the cassette 17 and operates a pipette pump assembly (not shown) within the cassette 17 such that fluid is either drawn into the pipette or expelled from the pipette due to the plunger 52 compressing the pump pin.

Further, the lead screw motor 45 can be rotatably coupled to a lead screw shaft 53 and controls clockwise and counterclockwise rotation of the lead screw shaft 53. In one embodiment, the lead screw motor 45 can be positioned behind the receptacle 42 within the module 40, and the lead screw shaft 53 can extend horizontally into the receptacle 42. The lead screw shaft 53 engages with the lead screw (not shown) of the cassette 17 in order to control lateral movement of the pipette within the cassette 17. In this regard, rotating the lead screw shaft 53 in a clockwise direction causes the lead screw to rotate in a clockwise direction such that the pipette travels laterally in one direction within the cassette 17, while rotating the lead screw shaft 53 in a counterclockwise direction causes the lead screw to rotate in a counterclockwise direction such that the pipette travels laterally in the opposite direction within the cassette 17. Control of the cam bar, pump pin, and lead screw of the cassette 17 allows the module 40 to manipulate the pipette within the cassette 17 such that the pipette removes fluids from reagent chambers (not shown) or a sample chamber (not shown) within the cassette 17, or injects fluids into a reagent chamber or detection chamber (not shown) within the cassette 17.

The heater assembly 46 includes a plurality of heaters 55. In one embodiment, the heater assembly 46 can be positioned directly below the receptacle 42 within the module 40. Each heater 55 is positioned upon an adjustable base 56 which may move in a vertical direction to adjust the vertical position of the heater 55. In addition, each heater 55 has a recess (not shown) for receiving a sample chamber or a detection chamber located in a bottom of the cassette 17. The heater assembly 46 further includes a base motor 57, a base plate 58 and a track 59. The base plate 58 is coupled to each of the adjustable bases 56, and the base plate 58 slideably engages with the track 59 in order to facilitate horizontal movement of the heaters 55 along the track 59. In one embodiment, the motor 57 rotatably engages with the base plate 58 in order to facilitate horizontal movement (parallel to the x-direction) of the base plate 58. Thus, when adjustment of the horizontal position of the heaters 55 is desired, the motor 57 causes the base plate 58 to slide horizontally along the track 59 a desired distance.

The module 40 further includes the lifter assembly 47 positioned beneath the heater assembly 46. The lifter assembly 47 includes at least one cam 60 and at least one sensor 61. In one embodiment, the assembly 47 includes two cams 60 and two sensors 61, although other numbers of cams 60 and sensors 61 are possible in other embodiments. The cams 60 can rotate and contact a heater base 56 in order lift the heater 55 into contact with the sample chamber or detection chamber of the cassette 17. The sensor 61 corresponding to each cam 60 can detect whether the cam 60 is in the home position and to transmit such detection to the onboard control element of module 40.

As shown in FIG. 3, the cam bar motor 43 can be coupled to a pulley 65 via a belt 66. The pulley 65 is positioned around and coupled to an outer surface of the cam bar shaft 50. The cam bar motor 43 can be coupled to the onboard control element, which can control the operation of the cam bar motor 43 based on predefined settings from the control element 15. When the cam bar motor 43 rotates, the belt 66 rotates in the motor's direction of rotation thereby engaging the pulley 65 and causing the cam bar shaft 50 to rotate in the same direction. The rotation of the cam bar shaft 50 causes rotation of the cassette's cam bar which adjusts the vertical position of the pipette within the cassette 17. In one embodiment, a cam bar shaft sensor 67 can be positioned behind the cam bar shaft 50 and the pulley 65, and the cam bar shaft sensor 67 can detect the cam bar shaft 50 when the shaft 50 extends through the sensor 67. The sensor 67 transmits a signal to the onboard control element when the cam bar shaft 50 is detected in order to detect insertion of the cassette 17 and maintain the cassette 17 within the receptacle 42 for processing.

The pump pin motor 44 is coupled to the plunger 52 and controls the horizontal position of the plunger 52. The pump pin motor 44 is coupled to the onboard control element, and the onboard control element controls the operation of the pump pin motor 44 in order to manipulate the plunger 52 for performing the process within the cassette 17. The lead screw motor 45 can be coupled to a pulley (not shown in FIG. 3) which is coupled around an outer surface of the lead screw shaft 53. In one embodiment, the lead screw motor 45 is coupled to the pulley via a belt 68. When the lead screw motor 45 rotates, the belt 68 rotates in the same direction and engages the pulley such that the pulley and the lead screw shaft 53 pivot in the same direction. Rotation of the lead screw shaft 53 causes the lead screw of the cassette 17 to rotate thereby adjusting the horizontal position of the pipette within the cassette 17 and facilitating the process. The module 40 further includes a lead screw shaft sensor 69 positioned behind the lead screw shaft 53 and the pulley. The sensor 69 can detect the shaft 53 and inform the onboard control element of the shaft's position in order to ensure that the shaft 53 has properly engaged with the cassette 17.

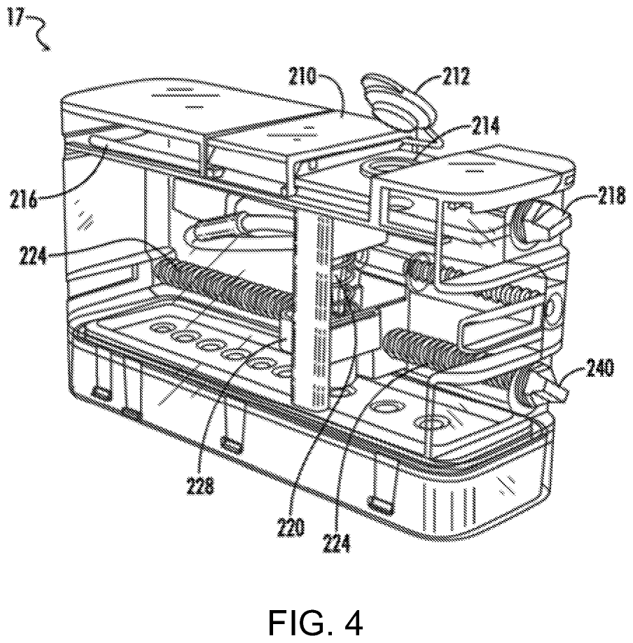

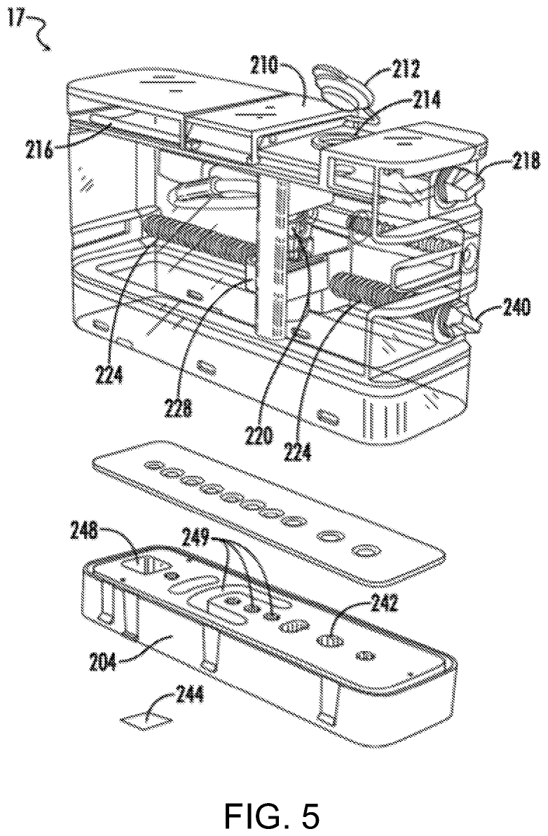

FIGS. 4 and 5 show an exemplary embodiment of a cassette 17. The cassette 17 has a pipette 220 that can be operably connected to a rotatable cam bar 216 so that rotation of the cam bar 216 results in a corresponding movement of the pipette 220 upward and/or downward in a vertical direction. A pipette holder 228 can support and guide the up and down movement of the cassette pipette 220. The pipette holder 228 can be supported by and slidably positioned within the cassette 17. A lead screw 224 can be positioned within the cassette 17 and can be operably connected to the pipette holder 228 so that rotation of the lead screw 224 produces a corresponding lateral movement of the pipette holder 228, thereby permitting the pipette 220 to be positioned above the appropriate fluid well in a base 204 of the cassette at each stage of the amplification/detection process.

The base 204 of the cassette 17 includes at least one sample chamber 242, and at least one reagent chamber 249 for containment of reagents (not shown). Each reagent chamber 249 may be of identical, similar, or dissimilar size, shape, and depth and may be arranged in a variety of positions in the base 204 of the cassette 17. Desired reagents (not shown) are placed within the appropriate reagent chambers 249 so that the cassette pipette 220 may gather the reagents needed for the extraction and the two-step, two-primer-set amplification as the process proceeds within the cassette 17. Reagent chambers 249 may be pre-loaded and preferably sealed prior to shipping, with the sealing material being a material that remains in place during shipping and storage but that can be readily punctured by the force of downward motion of the cassette pipette 220 in order to access (or open) the reagent chamber 249 to allow retrieval of the contents using the cassette pipette 220. One such material that is appropriate for sealing the reagent chamber 249, either individually, or as a group, is a thin sheet of aluminum foil (not shown). In an embodiment, among the reagent chambers 249 in the base 204 can be two reagent chambers 249 which contain target-specific primers and common, non-target-specific primers, respectively. The primers can be used for the first and second amplification reactions, the first amplification being target-specific to provide amplicons representing the DNA and/or RNA of the variety of targets which may be found within the sample, and the second amplification being primed by common primers to allow semi-quantitative non-specific amplification of the amplicons of the first amplification. In this two-step process, the first amplification being primed by target-specific primers provides specificity, while the second amplification being primed by common primers increases sensitivity.

Also provided in the base 204 of the cassette 17 can be a detection chamber 248 containing a microarray 244 for detection of the DNA which may have been amplified during a two-step dam-PCR protocol. Microarrays are known in the art and methods for preparing target-specific microarrays are well-known to those of skill in the art.

A fill port 214 in the top of the cassette 17 allows a user to insert a pipette (not shown) from the environment outside the cassette 17 into a sample chamber 242. A clear plastic window (not shown) may be formed in the cassette 17 to permit the user to see the user's pipette tip (not shown) as it is being inserted into the cassette 17 to deposit the sample (not shown) to be analyzed. In one embodiment, the clear viewing window is constructed to withstand the temperature extremes of the cassette 17. Alternatively, the entire enclosure of the cassette 17 may be formed from transparent or translucent plastics allowing the user to visualize the inner workings of the cassette 17.

In one embodiment, the fill port cap 212 located on top of the cassette can be a one-time operation cap, meaning that once the cap is sealed after sample insertion it cannot be reopened, thereby maintaining the integrity of the seal and keeping the system closed. In another embodiment, a sliding door 210 may be utilized such that once the sample (not shown) is introduced into the cassette 17, the sliding door 210 may be slid and locked into place. The fill port cap 212 seals the fill port 214. In one embodiment, the fill port 214 has a minimum inside diameter of 0.3 inches to allow for insertion of a 20 μl pipette through the fill port 214 and into the sample chamber 242. The fill port 214 may have larger or smaller diameters in other embodiments.

Movement of the cassette pipette 220 in a vertical, up-and-down manner, is provided by a cam bar 216 which is connected to the processor module 40 by a mechanical interface 218 immovably coupled to the cam bar 216, allowing movement of the cassette pipette 220 to be controlled by the processor module 40. In one embodiment, the mechanical interface 218 is a knob, however, other mechanical interfaces may be used in other embodiments.

The cassette pipette 220 can be supported and held in position by a pipette holder 228. The pipette holder 228 can be slidably received along the length of the cassette 17. The pipette holder 228 may be retained along the same lateral plane of the cassette 17 by a first and second guiderail (not shown), which can be molded into the sides of the cassette 17. Such guiderails may be positioned vertically parallel to each other and horizontally positioned between the ends of the cassette 17. The pipette holder 228 can be operably connected to the lead screw 224. The lead screw 224 can be threadedly received into the pipette holder 228 by a male-female thread pairing between the lead screw 224 and the pipette holder 228. A mechanical interface 240 is immovably connected to the lead screw 224 allowing both clockwise and counterclockwise rotation. Rotation of the mechanical interface 240 rotates the lead screw 224, the pipette holder 228 follows the thread of the lead screw 224 and is moved laterally along the lead screw 224 along the length of the cassette 17. Reversing the direction of rotation of the lead screw 224 causes a corresponding reversal of motion of the pipette holder 228. By controlling the number of rotations and direction of rotation of the lead screw 224, the pipette can be accurately positioned above any one of the reagent chamber 249 or sample chamber 242 located in the base 204. In one embodiment, the mechanical interface 240 is a knob, however, other types of mechanical interfaces may be used in other embodiments. It is understood that the cassette 17 of FIGS. 4 and 5 is exemplary, and other types of cassettes may be used in other embodiments.

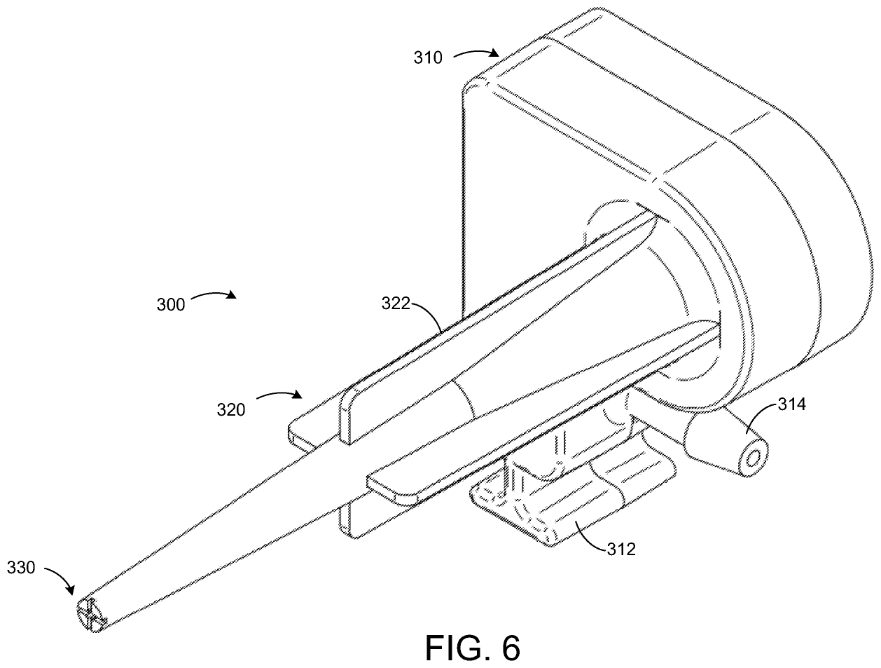

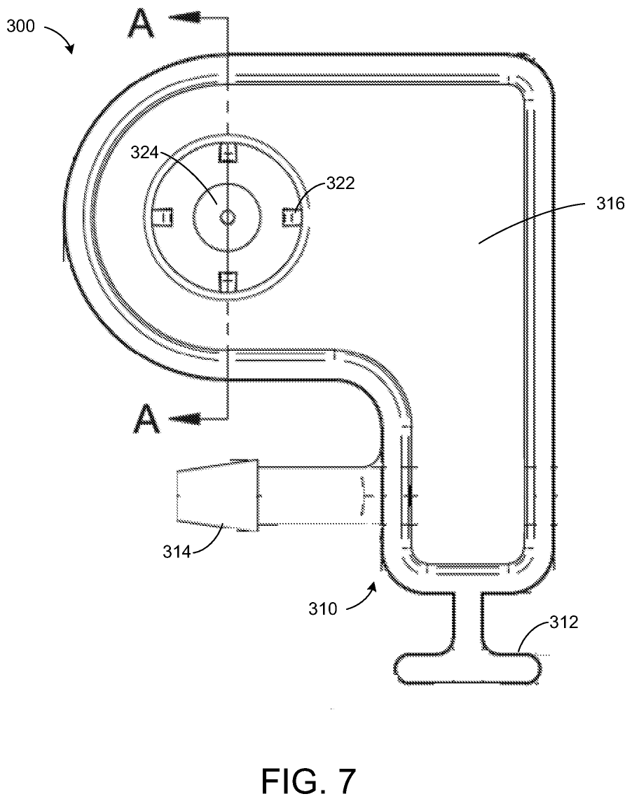

FIGS. 6 and 7 show an embodiment of a pipette 300 that can be used as pipette 220 within cassette 17 in one embodiment. However, the pipette 300 can be used in other cassettes or can be used outside of a cassette as a stand-alone device in other embodiments. The pipette 330 can be used to transfer liquid and/or solid state beads between containers. The pipette 300 can include a first portion 310, a second portion 320 and a third portion 330. In one embodiment, the third portion 330 can be an integral part of the pipette 300 as shown in FIG. 6. However, in other embodiments, the third portion 330 can be configured as a separate tip that can be removably attached to the pipette 300.

The first portion 310 can include a mounting interface 312, a pump interface 314 and a reservoir 316. In one embodiment, the mounting interface 312 can include a T-shaped bracket that can be slid into and engaged with a corresponding slot (not shown) of a pipette holder (e.g., pipette holder 228) in order to mount the pipette 300 in the pipette holder 228. Once the pipette 300 is mounted in the pipette holder 228, the pipette 300 can be moved vertically and/or horizontally within the cassette 17 through movement of the pipette holder 228 by the lead screw 224 and/or the cam bar 216. The pump interface 314 can be connected to the pipette pump assembly by a tube (not shown) that is coupled to the pump interface 314. The pipette pump assembly can then be operated to either z(1) draw a vacuum within the pipette 300 such that fluid or other material, such as beads, is drawn into the pipette 300 or (2) provide a pressure within the pipette 300 such that fluid or other material, such as beads, is expelled from the pipette 300. The reservoir 316 in the pipette 300 can be used to store a liquid or other items (e.g., beads). In one embodiment, the reservoir 316 can be used to store a liquid or other items (e.g., beads) used in either arm-PCR or dam-PCR. For example, the reservoir 316 can be used to store reagent drawn into the pipette 300 from a reagent chamber 249 and then transported, by the pipette 300, to a sample chamber 242 for subsequent dispersal into the sample chamber 242.

The second portion 320 can have an elongated conical shape that connects the first portion 310 to the third portion 330. To provide rigidity to the pipette 300, the second portion 320 can include one or more fins 322. In one embodiment, as shown in FIGS. 6 and 7, the fins 322 can be located on both interior and exterior surfaces of the second portion 320, but may be located on only the interior or exterior surface in other embodiments. The second portion 320 can include a central channel 324 for the flow of liquid between the reservoir 316 and the third portion 330. The central channel 324 can have a substantially circular cross-section with a first, larger diameter at the reservoir 316 and a second, smaller diameter at the third portion 330. In other embodiments, the central channel 324 can have different cross-sectional shapes such as an oval, square, triangle or rectangle. The central channel 324 can have one or more tapered sections where the diameter of the central channel is reduced at a fixed rate or otherwise between the first diameter and the second diameter.

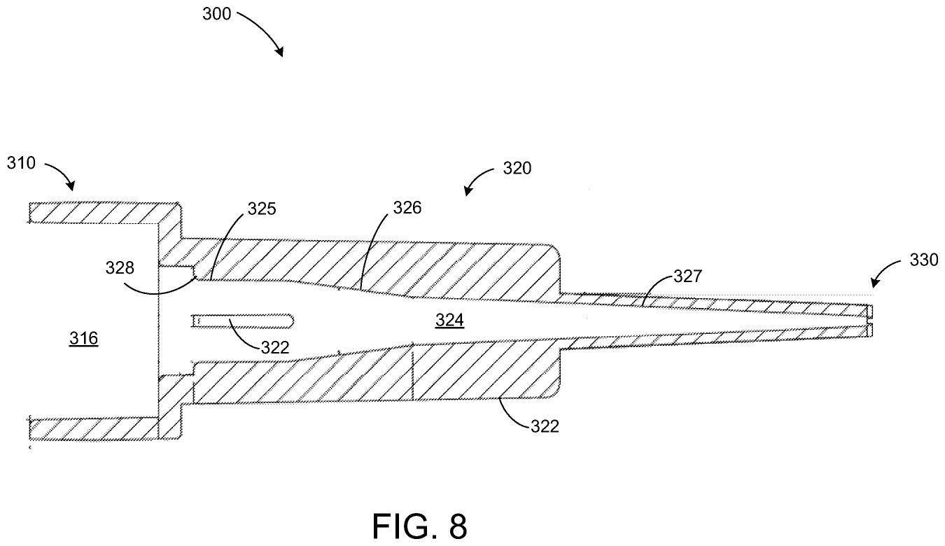

FIG. 8 shows a cross-sectional view of an embodiment of the pipette 300. As shown in FIG. 8, the central channel 324 can have three sections, though other numbers of sections are possible in other embodiments. The first section 325 of the central channel 324 can have a cylindrical shape with a substantially constant diameter, but may, in some embodiments, include a stepped portion 328 with a larger diameter to permit the central channel 324 to interface with the reservoir 316. The first section 325 can transition to the second section 326. The second section 326 can have a conical shape with a taper that results in a reducing diameter for the central channel 324 as the center channel 324 travels away from the first portion 310. In one embodiment, the taper of the second section 326 can be between about 12 degrees and about 18 degrees. The second section 326 can transition to the third section 327. The third section 327 can have a conical shape with a taper that results in a reducing diameter for the central channel 324 along a longitudinal axis of the channel 324 away from the first portion 310. In one embodiment, the taper of the third section 327 can be between about 2 degrees and about 4 degrees.

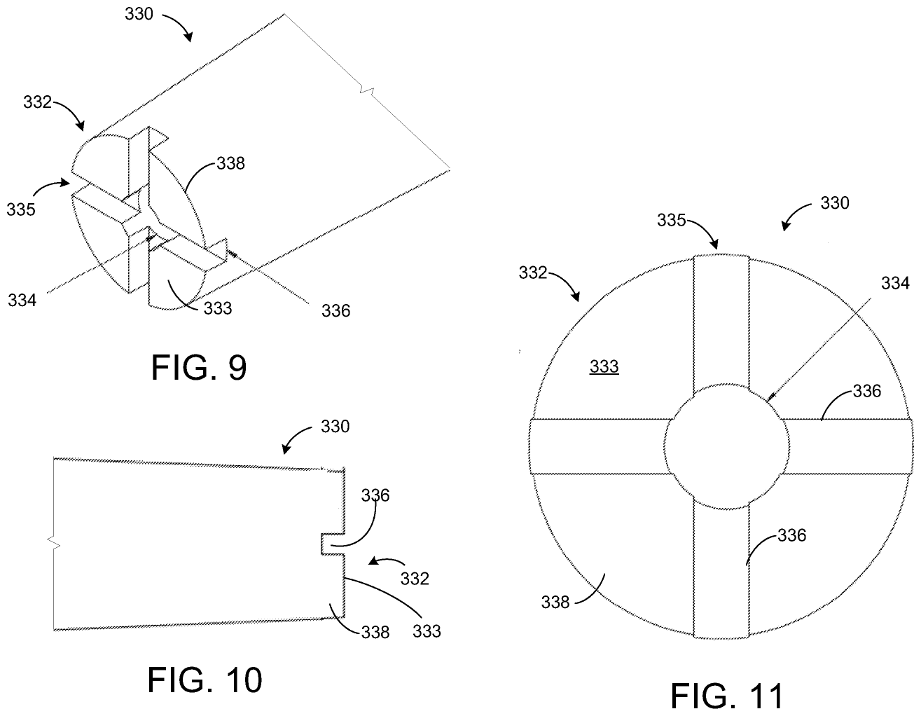

FIGS. 9-11 show the third portion 330 of the pipette 300. The third portion 330 can include a tip portion 332 to transfer liquid between the pipette 300 and a chamber or well. The tip portion 332 can include a central opening 334 in fluid communication with the central channel 324. In one embodiment, the central opening 334 of the tip portion 332 can have a substantially cylindrical shape, but other shapes are possible in other embodiments. In another embodiment, the central opening 334 can be integral with the central channel 324. Extending radially from the central opening 334 are a plurality of passageways 336 that provide for the flow of a material between the central opening 334 (and center channel 324) and an area outside of the pipette 300 (or exterior to the pipette 300). In one embodiment, the passageways 336 can have a substantially square-shaped cross-section, but may have different cross-sectional shapes (e.g., rectangular or circular) in other embodiments. The passageways 336 can be sized to permit the transfer of liquid and/or other materials (e.g., beads) between the pipette 300 and a chamber or well. In one embodiment, the passageways can have a width between about 0.005 inches and about 0.01 inches and a height between about 0.005 inches and about 0.01 inches, though other dimensions are possible in other embodiments.

As shown in the embodiment of FIGS. 9-11, there can be four passageways 336 extending from the central opening 334. However, in other embodiments, there can be more or less than four passageways 336 extending from the central opening 334. In one embodiment, the passageways 336 can be evenly spaced or positioned about the central opening 334. For example, in FIGS. 9-11, the passageways can be positioned about 90 degrees apart such that pairs of passageways 336 are substantially aligned. However, in other embodiments, the passageways 336 may be unevenly spaced about the central opening 334. For example, a passageway 336 may be positioned about 60 degrees apart from one neighboring passageway 336 and about 120 degrees apart from another neighboring passageway 336.

The tip portion 332 can also include corresponding wedge portions 338 to separate the passageways 336 and provide the sidewalls for the passageways 336. Each wedge portion 338 can have an end surface 333 that can contact the bottom surface of a chamber or well when the pipette 300 is inserted into the chamber or well. In one embodiment, the end surface 333 of the wedge portions 338 can have a shape that substantially forms a seal with the bottom surface of the chamber or well when the end surface 333 is moved into contact with the bottom surface of the chamber or well. As an example, the contour of the wedge portions 338 may correspond to the contour of the bottom surface of the chamber or well such that snug contact is made between the wedge portions 338 and the bottom surface along a perimeter or at least an edge of each wedge portion 338. In one embodiment, the end surface 333 can be substantially planar to mate with a substantially planar bottom surface of the chamber or well. However, in other embodiments, the end surface 333 can have different shapes (e.g., arcuate) to mate with corresponding bottom surfaces of the chamber or well.

Note that substantially sealing the area between wedge portions 338 the surface of the chamber or well helps to prevent leakage for the flow of material passing through the passageways 336. Preventing such leakage helps to maintain a higher pressure within the passageways 336, thereby helping to maintain higher flow rates or suction forces. Thus, when expelling material through the passageways 336 into the chamber or well, a higher flow rate can be achieved such that better agitation occurs. When pulling material from the chamber or well into the pipette, higher forces for pulling the material can be achieved.

In one embodiment, the passageways 336 can provide for a flow of liquid that is substantially perpendicular to the flow of liquid in the central channel 324. However, in other embodiments, the flow of liquid in the passageways 336 can be at angle greater than or less than 90 degrees with respect to the flow of liquid in the central channel 324. In another embodiment, the end surfaces 333 of each of the wedge portions 338 can be extended to form an integral surface that closes or seals the central opening 334 and/or the passageways 336 such that all fluid flow is through the passageway openings 335 in the cylindrical outer wall along the perimeter of the tip portion 332. In a further embodiment, a conical distributor can be located in the central opening 334 to improve the flow of liquid between the passageways 336 and the center channel 324.

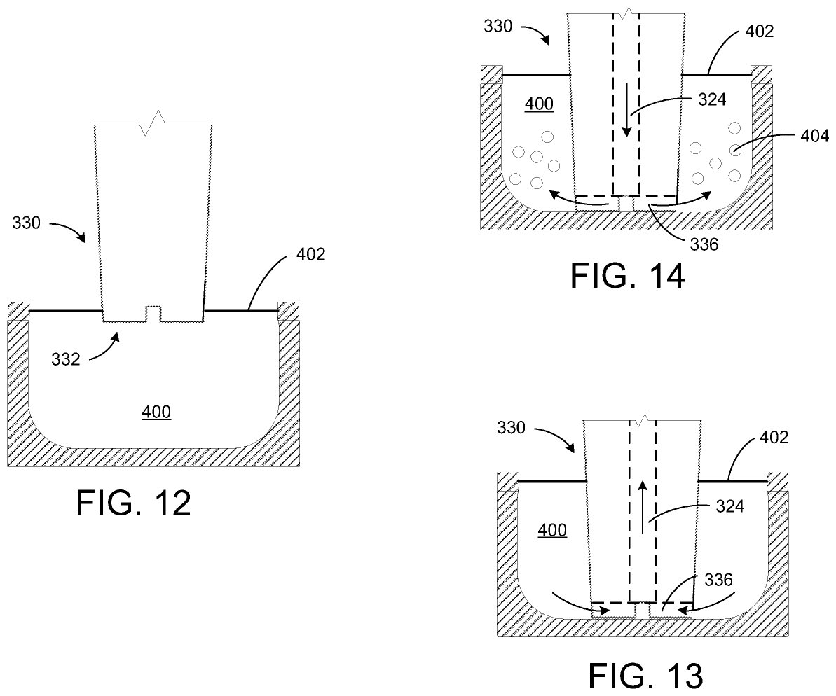

FIGS. 12-14 show different interactions of the pipette 300 with a chamber or well 400. In one embodiment, the chamber or well 400 may correspond to a chamber or well located in base 204 of the cassette 17, but, in other embodiments, the chamber or well 400 may be a stand-alone chamber or well or incorporated into another device. FIG. 12 shows the tip portion 332 of the third portion 330 of the pipette 300 piercing or puncturing the sealing material (e.g., a metal foil) 402 for a chamber or well 400. For example, the chamber or well 400 may be a reagent chamber storing a reagent used in one of the steps of a process including but, not limited to, dam-PCR or arm-PCR. After piercing the sealing material 402, the tip portion 332 may be moved into contact with the bottom surface of the chamber or well 400 as shown in FIG. 13 such that all or most of the end surfaces 333 of the wedge portions 338 are in contact with the bottom surface of the chamber or well 400.

Once the tip portion 332 is in contract with the bottom surface of the chamber 400 as shown in FIG. 13, the pipette 300 can be used to extract the liquid (or other material) from the chamber 400. The liquid (or other material) can flow through the passageways 336 to the center channel 324 as shown by the arrows in FIG. 13. The positioning of the tip portion 332 in contact with the bottom surface of the chamber 400 permits the pipette 300 to extract substantially all of the liquid (or other material) that has been stored in the chamber 400.

FIG. 14 shows the tip portion 332 in contact with the bottom surface of the chamber 400 similar to the configuration shown in FIG. 13. However, the pipette 300 is not extracting liquid (or other materials) as shown in FIG. 13, but is instead providing (or expelling) liquid (or other materials) into the chamber 400. The liquid (or other material) can flow through the center channel 324 and the passageways 336 into the chamber 400 as shown by the arrows in FIG. 14. The positioning of the tip portion 332 in contact with the bottom surface of the chamber 400 in conjunction with the size and placement of the passageways 336 permits the flow of liquid from the passageways 336 to generate turbulence within the chamber 400. The generation of the turbulence in the chamber 400 can agitate any beads 404 located in the chamber such that the beads 400 can become suspended within the liquid in the chamber 400. For example, a plurality of beads 404 may be located on the bottom surface of the chamber 400 after the completion of a step during a particular process. After the pipette 300 is positioned in the chamber 400, as shown in FIG. 14, the flow of liquid through the passageways 336 can move and agitate the beads 404 such that the beads 404 can become suspended in the liquid being provided into the chamber 400.

While the pipette 300 has been described generally with respect to cassette 17 and/or system 10, it is to be understood that the pipette 300 can be used with any cassette or system. In addition, the pipette 300 does not have to be incorporated into a cassette and may be used as part of a stand-alone device by an individual to manually perform steps in a process.

It should be understood that the identified embodiments are offered by way of example only. Other substitutions, modifications, changes and omissions may be made in the design, operating conditions and arrangement of the embodiments without departing from the scope of the present application. Accordingly, the present application is not limited to a particular embodiment, but extends to various modifications that nevertheless fall within the scope of the application. It should also be understood that the phraseology and terminology employed herein is for the purpose of description only and should not be regarded as limiting.

Now, therefore, the following is claimed:

1. A pipette comprising:
a first portion;
a second portion coupled to the first portion, the second portion having a channel to permit flow of material through the second portion; and
a third portion coupled to the second portion, the third portion comprising a tip portion having an opening in fluid communication with the channel and a plurality of passageways extending radially from the opening, the plurality of passageways configured to permit flow of material between the channel and an area exterior to the pipette.

2. The pipette of claim 1, wherein the plurality of passageways comprise 4 passageways spaced about 90 degrees apart.
